(19) United States
(12) Patent Application Publication
(10) Pub. No.: US 2024/0157365 A1
(43) Pub. Date: May 16, 2024

(54) SYSTEMS AND METHODS FOR THERMAL MANAGEMENT OF REAGENT WELL PLATES

(71) Applicant: 10x Genomics, Inc., Pleasanton, CA (US)

(72) Inventors: Jack HERRERA, Foster City, CA (US); Hendricus MARINDRA, Pleasanton, CA (US); Denis PRISTINSKI, Dublin, CA (US)

(73) Assignee: 10x Genomics, Inc., Pleasanton, CA (US)

(21) Appl. No.: 18/507,360

(22) Filed: Nov. 13, 2023

Related U.S. Application Data
(60) Provisional application No. 63/384,054, filed on Nov. 16, 2022.

(51) Int. Cl. B01L 3/00; F25B 21/00

(52) U.S. Cl. CPC B01L 3/50851; F25B 21/00; B01L 2300/1894

(57) ABSTRACT

The present disclosure relates to systems and methods for thermal management of well plates. In various embodiments, an apparatus for performing thermal management includes a thermal transfer block configured to receive a well plate having a plurality of wells, wherein the thermal transfer block comprises a base and a plurality of protrusions arranged on a first side of the base in a configuration such that each of the plurality of wells is received between a set of adjacent protrusions, and wherein each protrusion of the set of adjacent protrusions has a surface that substantially matches a portion of an outer surface of each well that is received between the set of adjacent protrusions; and a cooling block disposed in contact with a second side of the base of the thermal transfer block, wherein the cooling block comprises a heat sink having a plurality of fins immersed in a fluid for cooling.

### CROSS REFERENCE TO RELATED APPLICATIONS

This application is a continuation application of International (PCT) application serial number PCT/US23/79461, filed Nov. 13, 2023 which claims priority to U.S. provisional patent application Ser. No. 63/384,054, filed Nov. 16, 2022, the entire contents of which are incorporated herein by reference and relied upon.

### FIELD

The present disclosure generally relates to systems and methods for thermal management of well plates. More particularly, the present disclosure relates to systems, and methods of controlling the temperature of reagent well plates within an instrument having integrated optics and fluidics modules (e.g., an in situ analysis system).

### BACKGROUND

Analytical systems and tools used for imaging biological specimens require the specimens and/or any biological and/or chemical materials to be at an optimal experimental condition. This includes keeping biological specimens and/or chemical materials, such as reagents, buffer solutions, etc., at a desired temperature or within a desired range of temperatures. As off-the-shelf tools and/or components and currently existing solutions may not be adequate for use in state-of-the-art or next-generation systems/tools, there is a need for a highly precise and robust thermal management system that can meet the desired precision in thermal management of biological specimens and/or chemical materials.

### SUMMARY

In accordance with various embodiments, an apparatus is described. The apparatus includes a thermal transfer block configured to receive a well plate having a plurality of wells, wherein the thermal transfer block comprises a base and a plurality of protrusions arranged on a first side of the base in a configuration such that each of the plurality of wells is received between a set of adjacent protrusions, and wherein each protrusion of the set of adjacent protrusions has a surface that substantially matches a portion of an outer surface of each well that is received between the set of adjacent protrusions; and a cooling block disposed in contact with a second side of the base of the thermal transfer block, wherein the cooling block comprises a heat sink having a plurality of fins immersed in a fluid for cooling.

In various embodiments, the cooling block further includes a thermo-electric cooling module (TEC) disposed between the thermal transfer block and the heat sink, wherein the TEC module is configured to regulate a temperature or a range of temperature of the well plate via the thermal transfer block so as to maintain each of the plurality of wells at the temperature or within the range of temperature. In various embodiments, the cooling block further includes an aluminum plate disposed in between the TEC module and thermal transfer block. In various embodiments, the cooling block further includes a thermistor configured for measuring and controlling of the TEC module. In various embodiments, the cooling block further includes a proportional-integral-derivative (PID) controller configured to regulate the temperature of the plurality of wells within a predetermined temperature range. In various embodiments, the apparatus optionally includes an insulation element disposed around the thermal transfer block. In various embodiments, the apparatus optionally includes a radio-frequency identification (RFID) unit coupled to the cooling block.

In accordance with various embodiments, a method is described. In various embodiments, the method includes adjusting a temperature of a plurality of wells of a well plate via a thermo-electric cooling module (TEC) coupled to a plurality of protrusions extending between the plurality of wells of the well plate, wherein each of the plurality of wells is received between a set of adjacent protrusions.

In various embodiments, adjusting the temperature includes increasing a temperature of the protrusions. In various embodiments, adjusting the temperature includes decreasing a temperature of the protrusions. In various embodiments, the method optionally includes measuring, via a thermistor, the temperature of the plurality of wells. In various embodiments, the method optionally includes regulating, via a proportional-integral-derivative (PID) controller, the temperature of the plurality of wells within a predetermined temperature range. In various embodiments, the adjusting of the temperature includes energizing the TEC thereby decreasing the temperature of the plurality of wells. In various embodiments, the plurality of protrusions are coupled to a base that is in thermal contact with a first side of the TEC. In various embodiments, a second side of the TEC is in thermal contact with a heat sink having a plurality of fins immersed in a fluid.

In various embodiments, the method optionally includes cooling the TEC by flowing the fluid along the plurality of fins of the heat sink. In various embodiments, the fluid is introduced via an inlet and removed via an outlet. In various embodiments, each protrusion of the set of adjacent protrusions has a surface that substantially matches a portion of an outer surface of each well that is received between the set of adjacent protrusions so as to maximize heat transfer between the two surfaces. In various embodiments, between about 30% and about 95% of the outer surface area of the received well is in thermal contact with surfaces of the set of adjacent protrusions. In various embodiments, each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 illustrates a schematic diagram of an opto-fluidic instrument configured for imaging of biological specimens, in accordance with various embodiments.

FIGS. 2A and 2B illustrate a low use reagent (LUR) deck having a reagent well plate in thermal contact with a thermal transfer block disposed on a cooling block, in accordance with various embodiments.

FIGS. 3A and 3B illustrate a cooling block, in accordance with various embodiments.

FIGS. 4A and 4B depict cross-sections of simulation results of fluid velocity of liquid cooling using the cooling block of FIGS. 3A and 3B, in accordance with various embodiments.

FIG. 5 is a flowchart of an example method, in accordance with various embodiments.

FIG. 6 is a block diagram of a computer system, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

The embodiments encompassed herein relate to systems and methods for performing thermal management of biological specimens and/or chemical materials. In particular, the disclosure includes systems and methods of performing thermal management of reagent well plates, as example embodiments to illustrate the capability of the disclosed systems and methods. Through various embodiments as discussed herein, the disclosure relates to systems, components, and methods of controlling and regulating reagent well plates within an analytical system configured for imaging of biological specimens. In accordance with various embodiments, an apparatus for performing thermal management includes a thermal transfer block configured to receive a well plate having a plurality of wells, wherein the thermal transfer block includes a base portion (also referred to herein as a “base”) and a plurality of protrusions arranged on a first side of the base portion in a configuration such that each of the plurality of wells is received between a set of adjacent protrusions. In various embodiments, each protrusion of the set of adjacent protrusions that are in thermal contact with each of the wells has a surface that substantially matches a portion of an outer surface of each well that is received between the set of adjacent protrusions. In various embodiments, the apparatus includes a cooling block disposed in contact with a second side of the base portion of the thermal transfer block. In accordance with various embodiments, the cooling block includes a heat sink having a plurality of fins immersed in a fluid for cooling. In various embodiments, the fluid for cooling is pumped and recycled through a pump coupled to the colling block.

In accordance with various embodiments, a method of controlling and regulating reagent well plates. The method may include adjusting a temperature of the well plate having a plurality of wells via a thermo-electric cooling module (TEC) coupled to a plurality of protrusions extending between the plurality of wells of the well plate, wherein each of the plurality of wells is received between a set of adjacent protrusions. In various embodiments, the method may include adjusting the temperature by increasing or decreasing the temperature of the protrusions, and in various cases, using a thermistor to measure the temperature of the plurality of wells. In various embodiments, the method may include regulating, via a proportional-integral-derivative (PID) controller, the temperature of the plurality of wells within a predetermined temperature range. In various embodiments, the method may include adjusting of the temperature by energizing the TEC to decrease the temperature of the plurality of wells.

In various embodiments, the plurality of protrusions used in temperature regulating may be coupled to a base that is in thermal contact with a first side of the TEC, whereas a second side of the TEC is in thermal contact with a heat sink with a plurality of fins that are immersed in a fluid. In various embodiments, the method may include cooling the TEC by flowing the fluid along the plurality of fins of the heat sink, where the fluid can be introduced via an inlet and removed via an outlet.

In various embodiments, each protrusion of the set of adjacent protrusions has a surface that substantially matches a portion of an outer surface of each well that is received between the set of adjacent protrusions so as to maximize heat transfer between the two surfaces. In various embodiments, between about 30% and about 95% of the outer surface area of the received well is in thermal contact with surfaces of the set of adjacent protrusions. In various embodiments, each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

As further described below, the systems, apparatuses, and methods disclosed herein are configured for performing thermal management, for example, of a reagent well plate that contains chemical materials, such as reagents.

Descriptions and examples of various terms, as used herein, are provided in Section II below.

### II. Exemplary Descriptions of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

The term “ones” means more than one.

As used herein, the term “plurality” may be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

As used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in various embodiments.

### III. Opto-Fluidic Instruments for Analysis of Biological Samples

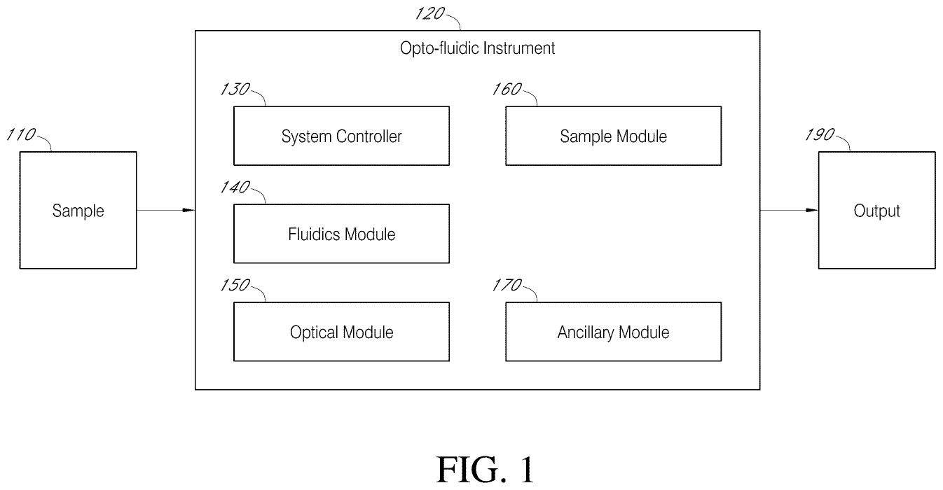

FIG. 1 illustrates a schematic diagram of an opto-fluidic instrument 120 configured for imaging of biological specimens, in accordance with various embodiments. As illustrated in FIG. 1, the opto-fluidic instrument 120 is configured for analyzing a sample 110 to generate an output 190.

In various embodiments, the sample 110 can be a biological sample (e.g., a tissue) that includes molecules targeted for analysis (i.e., target molecules), such as DNA, RNA, proteins, antibodies, etc. In various embodiments, the biological sample is a fresh frozen tissue. In various embodiments, the biological sample is a formalin-fixed paraffin-embedded (FFPE) sample. For example, the sample 110 can be a sectioned tissue that is treated to access the RNA thereof for labeling with circularizable DNA probes. In various embodiments, ligation of the probes generates a circular DNA probe which can be enzymatically amplified and bound with fluorescent oligonucleotides to produce a sufficiently bright signal that facilitates image acquisition and has a high signal-to-noise ratio.

In various embodiments, the sample 110 may be placed in the opto-fluidic instrument 120 for analysis and detection of the target molecules in the sample 110. In various embodiments, the opto-fluidic instrument 120 can be a system configured to facilitate the experimental conditions conducive for the detection of the molecules. For example, the opto-fluidic instrument 120 can include a fluidics module 140, an optics module 150, a sample module 160, and at least one ancillary module 170, and these modules may be operated by a system controller 130 to create the experimental conditions for the probing of the target molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components. In various embodiments, the various modules of the opto-fluid instrument may be in electrical communication with each other. In various embodiments, at least some of the modules of the opto-fluidic instrument 120 may be integrated together into a single module.

In various embodiments, the sample module 160 may be configured to receive the sample 110 in the opto-fluidic instrument 120. For instance, the sample module 160 may include a sample interface module (SIM) that is configured to receive a sample device (e.g., cassette) in which a substrate (having the sample 110 positioned thereon) can be secured. In various embodiments, the substrate is a glass slide. That is, the sample 110 may be placed in the opto-fluidic instrument 120 by securing the substrate having the sample 110 (e.g., the sectioned tissue) within the sample device that is then inserted into the SIM of the sample module 160. In various embodiments, the SIM includes an alignment mechanism configured to secure the sample device within the SIM and align the sample device in X, Y, and Z axes within the SIM. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along a two-dimensional (2D) plane of the opto-fluidic instrument 120. Additional discussion related to the SIM can be found in Applicant's U.S. application Ser. No. 18/328,200, filed Jun. 2, 2023, titled “Methods, Systems, and Devices for Sample Interface,” which is incorporated herein by reference in its entirety.

The experimental conditions that are conducive for the detection of the target molecules in the sample 110 may depend on the target molecule detection technique that is employed by the opto-fluidic instrument 120. For example, in various embodiments, the opto-fluidic instrument 120 can be a system that is configured to detect molecules in the sample 110 via sequencing by hybridization (SBH) technique. In such cases, the experimental conditions can be molecule hybridization conditions that result in the intensity of hybridization of the target molecule (e.g., nucleic acid) to a probe (e.g., oligonucleotide) being significantly higher when the probe sequence is perfectly complementary to the target molecule than when there is a single-base mismatch. The hybridization conditions include the preparation of the sample 110 using reagents such as washing/stripping reagents, hybridizing reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include one or more reservoirs configured to store the reagents, as well as a waste container configured for collecting the reagents (e.g., and other waste) after use by the opto-fluidic instrument 120 to analyze and detect the molecules of the sample 110. In various embodiments, the one or more reservoirs include one or more high use reagent reservoirs. In various embodiments, the fluidics module 140 may be configured to receive one or more low use reagent plates (e.g., a 96 deep well plate). Further, the fluidics module 140 may also include pumps, tubes, pipettes, etc., that are configured to facilitate the transport of the one or more reagents (such non-limiting examples may include high use reagent and/or low use reagent) to the sample device and thus contact the sample 110 with the reagent (such non-limiting examples may include high use reagent and/or low use reagent). For instance, the fluidics module 140 may include one or more pumps (“reagent pumps”) that are configured to pump washing and/or stripping reagents (i.e., high use reagents) to the sample device for use in washing and/or stripping the sample 110. In various embodiments, the fluidics module 140 may be configured for other washing functions such as washing an objective lens of the imaging system of the optics module 150.

In various embodiments, the ancillary module 170 includes a cooling system (i.e., a heat transfer system) of the opto-fluidic instrument 120. In various embodiments, the cooling system includes a network of coolant-carrying tubes configured to transport coolant to various modules of the opto-fluidic instrument 120 for regulating the temperatures thereof. In such cases, the ancillary module 170 may include one or more heat transfer components of a heat transfer circuit. In various embodiments, the heat transfer components include one or more coolant reservoirs for storing coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the heat transfer components of the ancillary module 170 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the ancillary module 170 may also include one or more cooling fans that are configured to force air (e.g., cool and/or ambient air) to the external surfaces of the returning coolant reservoirs to thereby cool the heated coolant(s) stored therein. In some instance, the ancillary module 170 may also include one or more cooling fans that are configured to force air directly to one or more components of the opto-fluidic instrument 120 so as to cool said one or more components. For one non-limiting example, the ancillary module 170 may include cooling fans that are configured to directly cool by forcing ambient air past the system controller 130 to thereby cool the system controller 130.

As discussed above, the opto-fluidic instrument 120 may include an optics module 150 which include the various optical components of the opto-fluidic instrument 120, such as but not limited to a camera, an illumination module (such non-limiting examples may include one or more LEDs and/or one or more lasers), an objective lens, and/or the like. The optics module 150 may be a fluorescence imaging system that is configured to image the fluorescence emitted by the probes (e.g., oligonucleotides) in the sample 110 after the probes are excited by light from the illumination module of the optics module 150. In some instances, the optics module 150 may also include an optical frame onto which the camera, the illumination module, and/or the X-Y stage of the sample module 160 may be mounted.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 is configured to analyze the sample 110 and generate the output 190 that includes indications of the presence of the target molecules in the sample 110. For instance, with respect to the example embodiment discussed above where the opto-fluidic instrument 120 employs the SBH technique for detecting molecules, the opto-fluidic instrument 120 may cause the sample 110 to undergo successive rounds of fluorescent probe hybridization and be imaged to detect target molecules in the probed sample 110. In such cases, the output 190 may include optical signatures specific to each gene, which allow the identification of the target molecules.

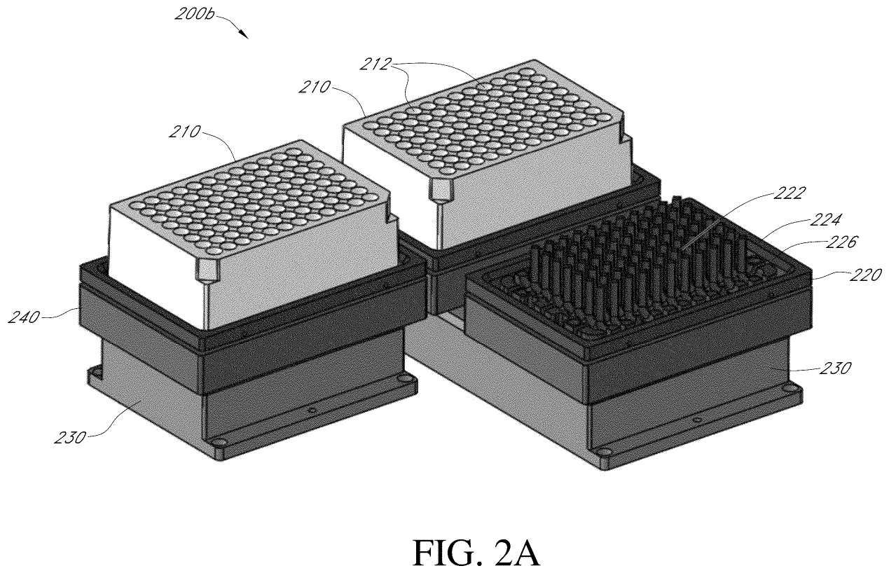

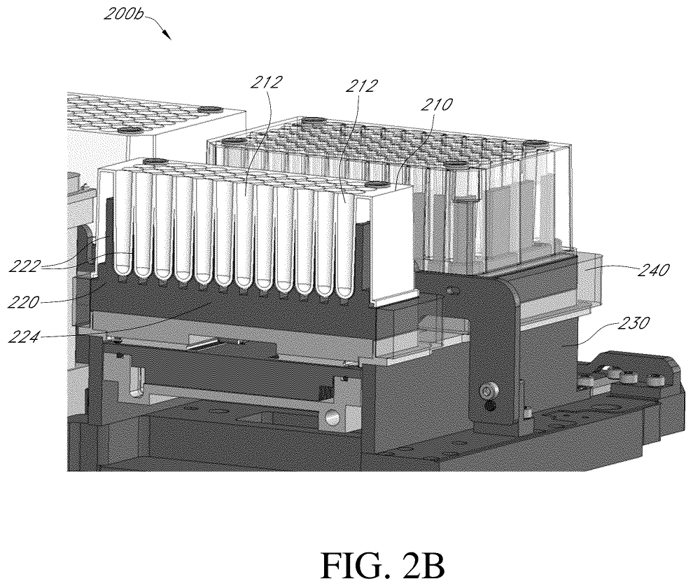

FIGS. 2A and 2B illustrate a low use reagent (LUR) deck 200a, 200b having a reagent well plate 210 (referred to herein as “well plate 210”) in thermal contact with a thermal transfer block disposed on a cooling block, in accordance with various embodiments. As shown in FIG. 2A, the LUR deck 200a includes the well plate 210 having a plurality of wells 212 that are placed on top of a thermal transfer block 220. In various embodiments, the thermal transfer block 220 includes a plurality of protrusions 222. In various embodiments, the protrusions 222 are configured to substantially fit in the space defined between each of the wells 212 of the well plate 210 to thereby improve heat transfer between the wells 212 and the thermal transfer block 220. For example, protrusions 222 may be disposed in between sets of adjacent of protrusions 222.

In various embodiments, the thermal transfer block 220 is a single piece of metal that is machined or otherwise formed into a plurality of protrusions 222. In various embodiments, the thermal transfer block 220 is formed using 3D-printing. In various embodiments, the thermal transfer block 220 has a base 224 (or a base portion) and the plurality of protrusions 222 arranged on a first (e.g., top) side of the base 224. In various embodiments, the plurality of protrusions 222 are formed as separate components, e.g., via machining or 3D printing, and subsequently attached to the base 224 to form the thermal transfer block 220. In various embodiments, the protrusions 222 are coupled to the base using one or more fasteners (e.g., screws, clips, pins, etc.). In various embodiments, the protrusions 222 are bonded to the base (e.g., with epoxy). In various embodiments, the protrusions 222 are fused to the base (e.g., friction welding or other welding process).

In various embodiments, each protrusion of the plurality of protrusions 222 has a surface that substantially matches a portion of an outer surface of each well 212 that is received between adjacent protrusions, as illustrated in FIG. 2B. In various embodiments, each of the plurality of protrusions 222 has a length along the protrusion 222 that substantially matches a depth of a fluid chemical in each well 212 such that the fluid chemical contained within each well, from a top surface of the fluid chemical to a bottom of the well, is in thermal contact with the matching contour surfaces adjacent protrusions. In various embodiments, each protrusion 222 has a shape or surface that conforms to the surface of the well 212 that is in contact with that protrusion. In various embodiments, each protrusion 222 is in contact with the well 212 such that a reduced (e.g., minimal) amount of air exists in-between the two surfaces, because air is generally an insulator and reduces heat transfer. In various embodiments, each protrusion 222 of the set of adjacent protrusions are tapered. In various embodiments, tapered protrusions enable ease of removing the well plate from the thermal transfer block 220.

In various embodiments, the surface of each protrusion 222 and the outer surface of the received well 212 have matching contour surfaces so as to maximize heat transfer between the two surfaces. In various embodiments, between about 30% and about 95% of the outer surface area of the received well 212 is in thermal contact with surfaces of the set of adjacent protrusions 222. In various embodiments, between about 35% and about 95%, between about 40% and about 95%, between about 45% and about 95%, between about 50% and about 95%, between about 55% and about 95%, between about 60% and about 95%, between about 65% and about 95%, between about 70% and about 95%, between about 75% and about 95%, between about 80% and about 95%, between about 85% and about 95%, between about 90% and about 95%, between about 35% and about 90%, between about 40% and about 90%, between about 45% and about 90%, between about 50% and about 90%, between about 55% and about 90%, between about 60% and about 90%, between about 65% and about 90%, between about 70% and about 90%, between about 75% and about 90%, between about 80% and about 90%, between about 85% and about 90%, of the outer surface area of the received well 212 is in thermal contact with surfaces of the adjacent protrusions 222.

In various embodiments, any individual well can be adjacent to 1, 2, 3, 4, 5, 6, 7, or 8 protrusions. In other words, any received well 212 can be in thermal contact with 1, 2, 3, 4, 5, 6, 7, or 8 protrusions 222.

In various embodiments, the base 224 and the plurality of protrusions 222 of the thermal transfer block 220 are formed from a single block of material. In various embodiments, the base 224 and/or the plurality of protrusions 222 of the thermal transfer block 220 are made from a high thermal conducting material, such as, for example but not limited to, aluminum, copper, and/or steel. In various embodiments, the thermal transfer block 220 includes a frame structure 226 configured for alignment, correct placement, and/or to ensure proper thermal contact of the well plate 210 onto/with the thermal transfer block 220.

As shown in FIGS. 2A and 2B, a second side of the thermal transfer block 220 is in (thermal) contact with a cooling block 230. Also illustrated is an insulation element 240 disposed around at least a portion of the thermal transfer block 220 and/or at least a portion of the cooling block 230. In various embodiments, the insulation element 240 includes foam.

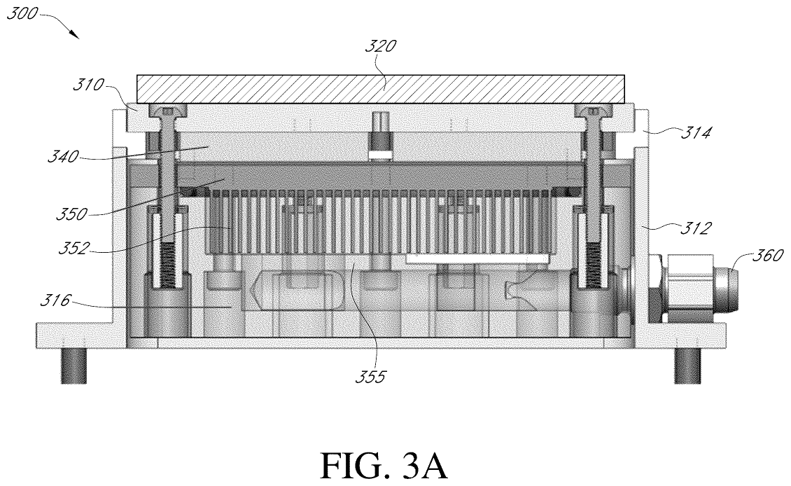

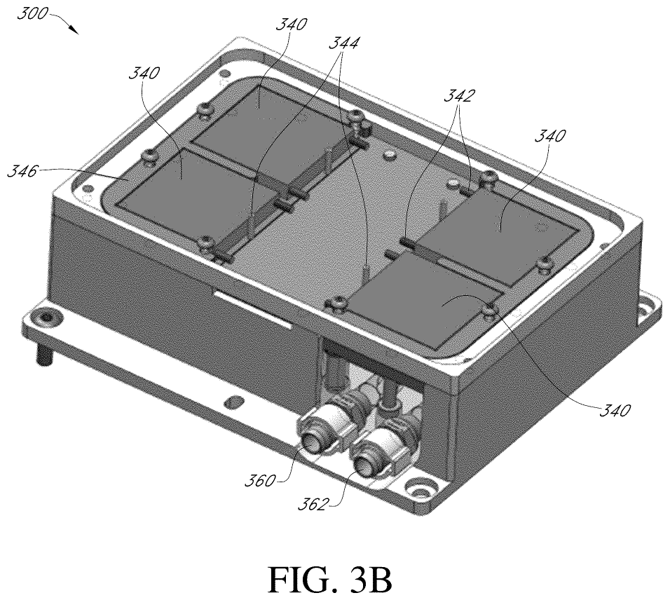

FIGS. 3A and 3B illustrate a cooling block 300, in accordance with various embodiments. As illustrated in FIGS. 3A and 3B, the cooling block 300 is in thermal contact with a thermal transfer block 320 and is configured to cool the thermal transfer block 320. In various embodiments, the thermal transfer block 320 is identical or substantially the same as the thermal transfer block 220 as described with respect to FIGS. 2A and 2B.

As shown in FIG. 3A, the cooling block 300 includes a plate 310 (optional), a housing 312, a plate rim 314, at least one thermo-electric cooling (TEC) module 340 (also referred to herein as “TEC 340”), a heat sink 350 having a plurality of fins 352 immersed in a fluid 355 for cooling. FIG. 3B illustrates the cooling block 300 without the optional plate 310. As illustrated, the housing 312 is configured to house a plurality of TECs 340 (e.g., four TECs) positioned within a TEC nest 346, the heat sink 350, and the fluid 355 within the housing, which can be enclosed by placing the plate 310 using the plate rim 314, in accordance with various embodiments. In various embodiments, the TEC nest 346 is shaped to allow for positioning and securement of each TEC 340 within the cooling block 300. In various embodiments, the plate rim 314 includes a thermal insulating material, i.e., non-thermal conducting material, that is configured to thermally insulate the housing 312 from the optional plate 310, which can be at an elevated temperature when in cooling operation, e.g., during cooling of the thermal transfer block 320. In various embodiments, the thermal insulating material is a polymer.

In various embodiments, the cooling block 300 further includes a configuration in which the TEC 340 is disposed between the thermal transfer block 320 and the heat sink 350, as shown in FIG. 3A. In various embodiments, the TEC 340 is configured to regulate a temperature or a range of temperature of the well plate (not shown, e.g., well plate 210 of FIGS. 2A and 2B) via the thermal transfer block 320 so as to maintain each of the plurality of wells (e.g., wells 212 of FIGS. 2A and 2B) at the temperature or within the range of temperature. As shown in FIG. 3B, the TECs 340 have power cables 342 supplying power to the TECs 340. In various embodiments, the cooling block 300 also includes a thermistor 344 for each of the TECs 340, wherein the thermistor 344 is configured for measuring the temperature of the plurality of wells. In various embodiments, the cooling block 300 also includes a controller (not shown) configured to regulate the temperature of the plurality of wells within a predetermined or preset temperature range. In various embodiments, the controller includes a proportional-integral-derivative (PID) controller. In various embodiments, the cooling block 300 also includes a radio-frequency identification (RFID) unit (not shown) coupled to the cooling block 300.

In various embodiments, the cooling block 300 is configured for cooling more than one thermal transfer block 320. In various embodiments, the cooling block 300 is configured for cooling two or three thermal transfer blocks 320. In various embodiments, a first thermal transfer block 320 and a second thermal transfer block 320 are thermally isolated from one another. In various embodiments, a first cooling block 300 is configured to be in thermal contact with the first thermal transfer block 320 and a second cooling block 300 is configured to be in thermal contact with the second thermal transfer block 320, wherein the second cooling block 300 is electrically isolated from the first cooling block 300, or vice versa.

In various embodiments, the first cooling block 300 is maintained at substantially a first temperature or within a first preset range of temperatures and the second cooling block 300 can be maintained at substantially a second temperature or within a second preset range of temperatures. The first temperature is different from the second temperature. The first preset range of temperatures can be different from the second preset range of temperatures.

In various embodiments, the cooling block 300 can be configured to maintain the temperature of the well plate at or about −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., or 21° C. In various embodiments, the cooling block 300 can be configured to maintain a range of temperature of the well plate between about −10° C. and about 10° C., between about −8° C. and about 8° C., between about −6° C. and about 6° C., between about −4° C. and about 4° C., between about −2° C. and about 2° C., between about −10° C. and about 0° C., between about −8° C. and about 0° C., between about −6° C. and about 0° C., between about −4° C. and about 0° C., between about −10° C. and about 2° C., between about −8° C. and about 2° C., between about −6° C. and about 2° C., between about −4° C. and about 2° C., between about −10° C. and about 4° C., between about −8° C. and about 4° C., between about −6° C. and about 4° C., between about −2° C. and about 4° C., between about 0° C. and about 4° C., between about −10° C. and about 6° C., between about −8° C. and about 6° C., between about −4° C. and about 6° C., between about −2° C. and about 6° C., between about 0° C. and about 6° C., between about 2° C. and about 6° C., between about −10° C. and about 8° C., between about −6° C. and about 8° C., between about −4° C. and about 8° C., between about −2° C. and about 8° C., between about 0° C. and about 8° C., between about 2° C. and about 8° C., between about 4° C. and about 8° C., between about −8° C. and about 10° C., between about −6° C. and about 10° C., between about −4° C. and about 10° C., between about −2° C. and about 10° C., between about 0° C. and about 10° C., between about 2° C. and about 10° C., between about 4° C. and about 10° C., between about 6° C. and about 10° C., inclusive of any temperature ranges therebetween.

In various embodiments, the TEC 340 can be configured to maintain the temperature of the well plate at or about −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., or 21° C. In various embodiments, the TEC 340 can be configured to maintain a range of temperature of the well plate between about −10° C. and about 10° C., between about −8° C. and about 8° C., between about −6° C. and about 6° C., between about −4° C. and about 4° C., between about −2° C. and about 2° C., between about −10° C. and about 0° C., between about −8° C. and about 0° C., between about −6° C. and about 0° C., between about −4° C. and about 0° C., between about −10° C. and about 2° C., between about −8° C. and about 2° C., between about −6° C. and about 2° C., between about −4° C. and about 2° C., between about −10° C. and about 4° C., between about −8° C. and about 4° C., between about −6° C. and about 4° C., between about −2° C. and about 4° C., between about 0° C. and about 4° C., between about −10° C. and about 6° C., between about −8° C. and about 6° C., between about −4° C. and about 6° C., between about −2° C. and about 6° C., between about 0° C. and about 6° C., between about 2° C. and about 6° C., between about −10° C. and about 8° C., between about −6° C. and about 8° C., between about −4° C. and about 8° C., between about −2° C. and about 8° C., between about 0° C. and about 8° C., between about 2° C. and about 8° C., between about 4° C. and about 8° C., between about −8° C. and about 10° C., between about −6° C. and about 10° C., between about −4° C. and about 10° C., between about −2° C. and about 10° C., between about 0° C. and about 10° C., between about 2° C. and about 10° C., between about 4° C. and about 10° C., between about 6° C. and about 10° C., inclusive of any temperature ranges therebetween.

In various embodiments, the TEC 340 can be configured for heating and cooling capabilities. In various embodiments, the cooling block may include a plurality of TECs 340 where each TEC 340 can be independently operable for heating and/or cooling. For example, a first TEC 340 can be configured to decrease a temperature, e.g., of a first well plate, whereas a second TEC 340 may be configured to increase a temperature, e.g., of a second well plate.

As illustrated in FIG. 3A, the heat sink 350 includes the plurality of fins 352. In various embodiments, the plurality of fins 352 of the heat sink 350 are formed via a skived piece of metal, such as a single block of aluminum or copper. In various embodiments, the plurality of fins 352 are parallel plates that run along an entire width or dimension of the heat sink 350. In various embodiments, the plurality of fins 352 may be a grid of posts that run along an entire width and length of the heat sink 350. In various embodiments, the grid of posts of the plurality of fins 352 may be arranged in any configuration suitable for efficiently extracting heat from the thermal transfer block 320.

As illustrated in FIGS. 3A and 3B, the cooling block 320 includes a chamber 316 formed within the housing 312 with an inlet 360 for introducing the fluid 355 into the chamber 316 for cooling the heat sink 350 and an outlet 362 for removing the fluid 355 that passes through the plurality of fins 352 of the heat sink 350. In various embodiments, the plurality of fins 352 of the heat sink 350 are arranged such that the fluid 355 flows along and in between the plurality of fins 352. In various embodiments, the heat sink 350 is arranged within the chamber 316 such that the plurality of fins 352 extend away from the thermal transfer block 312. In other words, the plurality of fins 352 extend downwardly into the fluid 355 whereas the base of the heat sink is in thermal contact with the TEC 340. In various embodiments, the fluid 355 is introduced via the inlet 360 into the chamber 316 such that the fluid flows along the plurality of fins 352 before exiting the chamber via the outlet 362. In various embodiments, the heat sink 350 is arranged within the chamber 316 such that the inlet 360 is perpendicular to the plurality of fins 352 of the heat sink 350. In various embodiments, the heat sink 350 is arranged within the chamber 316 such that the inlet 360 is parallel to the plurality of fins 352 of the heat sink 350. In various embodiments, the heat sink 350 is arranged within the chamber 316 such that the inlet 360 is oriented at an angle to the plurality of fins 352 of the heat sink 350. In various embodiments, the inlet 360 includes a splitter configured to spread the flow of the fluid 355 along the width of the chamber and provide more uniform flow along the heat sink 350.

In various embodiments, the plurality of fins 352 of the heat sink 350 extend from a top surface of the chamber 316 for an entire height of the chamber forming parallel channels of fluid flow from the inlet 360 to the outlet 362. In various embodiments, the plurality of fins 352 of the heat sink 350 extend from a top surface of the chamber 316 for a portion of a height of the chamber forming semi-parallel channels of fluid flow between the inlet 360 and the outlet 362. In various embodiments, the inlet 360 and the outlet 362 are arranged on a same side of the chamber. In various embodiments, the inlet 360 is arranged at a first side of the chamber 316 and the outlet 362 is arranged at a second side opposite the first side. In various embodiments, the inlet 360 is arranged at a first side of the chamber 316 and the outlet 362 is arranged at a second side perpendicular to the first side. In various embodiments, the inlet 360 is arranged at a first side of the chamber 316 and the outlet 362 is arranged at a second side opposite the first side.

In various embodiments, the heat sink 350 is arranged at a first side of the chamber 316 and the inlet 360 is arranged at a second side of the chamber opposite the first side. In various embodiments, the heat sink 350 is arranged at a first side of the chamber 316 and the outlet 362 is arranged at a second side of the chamber opposite the first side.

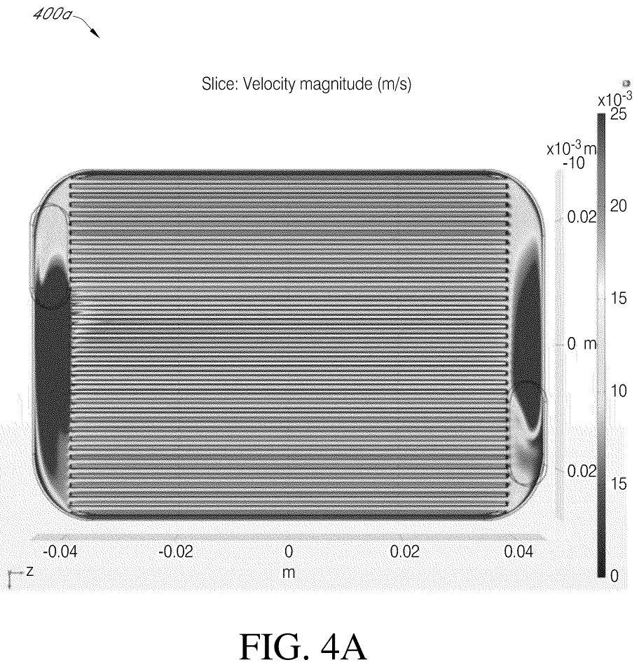

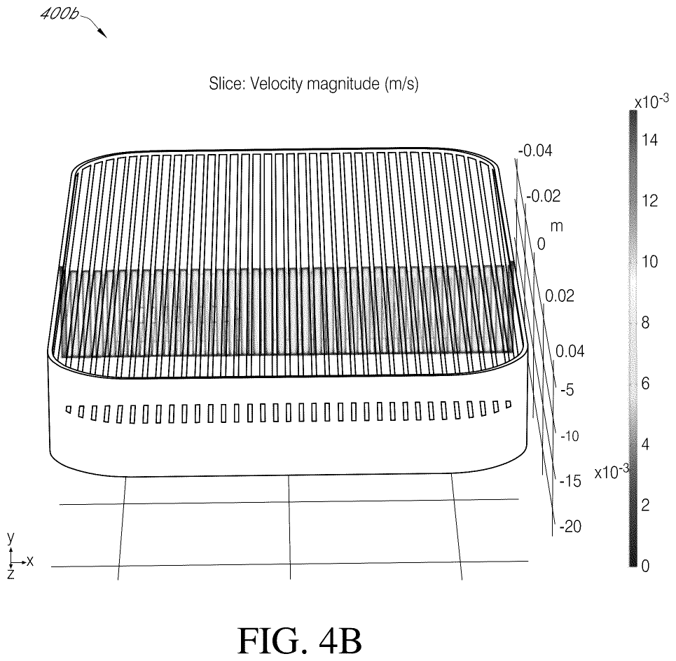

FIGS. 4A and 4B depict simulation results of liquid cooling using the cooling block of FIGS. 3A and 3B, in accordance with various embodiments. FIG. 4A shows a cross section of simulation results 400a of fluid velocity during liquid cooling using the heat sink 350 of the cooling block 300. FIG. 4B shows a cross-section of simulation results 400b of fluid velocity during liquid cooling using the cooling block 300.

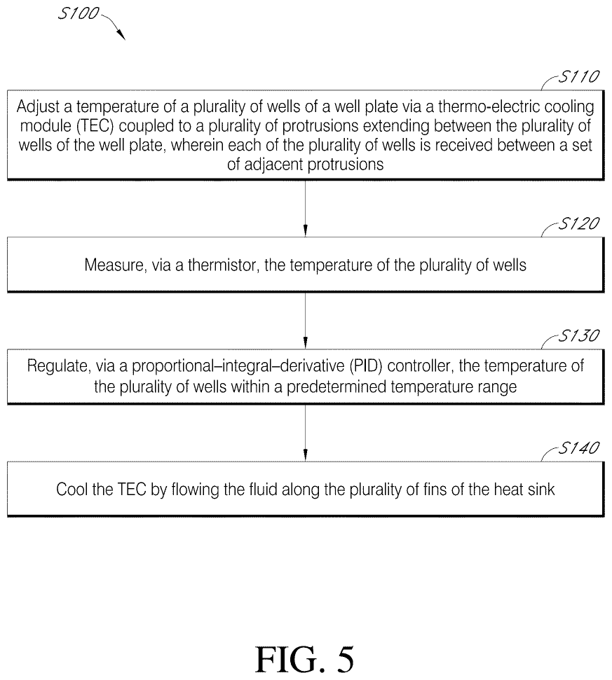

FIG. 5 is a flowchart of an example method S100, in accordance with various embodiments. As illustrated in FIG. 5, the method S100 includes, at step S110, adjusting a temperature of a plurality of wells of a well plate via a thermo-electric cooling module (TEC) coupled to a plurality of protrusions (of a heat sink, such as, heat sink 350) extending between the plurality of wells of the well plate, wherein each of the plurality of wells is received between a set of adjacent protrusions. In various embodiments, the TEC is identical or substantially similar to the TEC 340 of FIGS. 3A and 3B, and thus will not be described in further detail. In various embodiments, the plurality of the protrusions are identical or substantially similar to the protrusions 222 of FIGS. 2A and 2B, and thus will not be described in further detail. In various embodiments, adjusting the temperature may include increasing a temperature of the protrusions. In various embodiments, adjusting the temperature may include decreasing a temperature of the protrusions.

The method S100 further includes, optionally at step S120, measuring the temperature of the plurality of wells using a thermistor, such as the thermistor 344 of FIG. 3B.

The method S100 further includes, optionally at step S130, regulating the temperature of the plurality of wells within a predetermined temperature range via a proportional-integral-derivative (PID) controller. In various embodiments, the adjusting of the temperature may include energizing the TEC, e.g., TEC 340, to decrease the temperature of the plurality of wells.

In various embodiments, the TEC can be configured to maintain the temperature of a well plate at or about −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., or 21° C. In various embodiments, the TEC can be configured to maintain a range of temperature of the well plate between about −10° C. and about 10° C., between about −8° C. and about 8° C., between about −6° C. and about 6° C., between about −4° C. and about 4° C., between about −2° C. and about 2° C., between about −10° C. and about 0° C., between about −8° C. and about 0° C., between about −6° C. and about 0° C., between about −4° C. and about 0° C., between about −10° C. and about 2° C., between about −8° C. and about 2° C., between about −6° C. and about 2° C., between about −4° C. and about 2° C., between about −10° C. and about 4° C., between about −8° C. and about 4° C., between about −6° C. and about 4° C., between about −2° C. and about 4° C., between about 0° C. and about 4° C., between about −10° C. and about 6° C., between about −8° C. and about 6° C., between about −4° C. and about 6° C., between about −2° C. and about 6° C., between about 0° C. and about 6° C., between about 2° C. and about 6° C., between about −10° C. and about 8° C., between about −6° C. and about 8° C., between about −4° C. and about 8° C., between about −2° C. and about 8° C., between about 0° C. and about 8° C., between about 2° C. and about 8° C., between about 4° C. and about 8° C., between about −8° C. and about 10° C., between about −6° C. and about 10° C., between about −4° C. and about 10° C., between about −2° C. and about 10° C., between about 0° C. and about 10° C., between about 2° C. and about 10° C., between about 4° C. and about 10° C., between about 6° C. and about 10° C., inclusive of any temperature ranges therebetween.

In various embodiments, the TEC can be configured for heating and cooling capabilities. In various embodiments, the cooling block may include a plurality of TECs where each TEC can be independently operable for heating and/or cooling. For example, a first TEC can be configured to decrease a temperature, e.g., of a first well plate, whereas a second TEC may be configured to increase a temperature, e.g., of a second well plate.

In various embodiments, the plurality of protrusions are coupled to a base that is in thermal contact with a first side of the TEC, wherein a second side of the TEC is in thermal contact with a heat sink, e.g., heat sink 350 of FIGS. 3A and 3B, having a plurality of fins, e.g., fins 352, immersed in a fluid. In various embodiments, each protrusion of the set of adjacent protrusions has a surface that substantially matches a portion of an outer surface of each well that is received between the set of adjacent protrusions so as to maximize heat transfer between the two surfaces.

In various embodiments, between about 30% and about 95% of the outer surface area of the received well is in thermal contact with surfaces of the set of adjacent protrusions. In various embodiments, between about 35% and about 95%, between about 40% and about 95%, between about 45% and about 95%, between about 50% and about 95%, between about 55% and about 95%, between about 60% and about 95%, between about 65% and about 95%, between about 70% and about 95%, between about 75% and about 95%, between about 80% and about 95%, between about 85% and about 95%, between about 90% and about 95%, between about 35% and about 90%, between about 40% and about 90%, between about 45% and about 90%, between about 50% and about 90%, between about 55% and about 90%, between about 60% and about 90%, between about 65% and about 90%, between about 70% and about 90%, between about 75% and about 90%, between about 80% and about 90%, between about 85% and about 90%, of the outer surface area of the received well is in thermal contact with surfaces of the set of adjacent protrusions.

In various embodiments, each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

The method S100 further includes, optionally at step S140, cooling the TEC by flowing the fluid along the plurality of fins of the heat sink. In various embodiments, the fluid is introduced via an inlet into the chamber, e.g., chamber 316 of FIG. 3A, such that the fluid flows along the plurality of fins before exiting the chamber via an outlet. In various embodiments, the heat sink is arranged within the chamber such that the inlet is perpendicular to the plurality of fins. In various embodiments, the heat sink is arranged within the chamber such that the inlet is parallel to the plurality of fins. In various embodiments, the heat sink is arranged within the chamber such that the inlet is oriented at an angle to the plurality of fins.

In various embodiments, the plurality of fins extend from a top surface of the chamber for an entire height of the chamber forming parallel channels of fluid flow from the inlet to the outlet. In various embodiments, the plurality of fins extend from a top surface of the chamber for a portion of a height of the chamber forming semi-parallel channels of fluid flow between the inlet and the outlet. In various embodiments, the inlet and the outlet are arranged on a same side of the chamber. In various embodiments, the inlet is arranged at a first side of the chamber and the outlet is arranged at a second side opposite the first side. In various embodiments, the inlet is arranged at a first side of the chamber and the outlet is arranged at a second side perpendicular to the first side. In various embodiments, the inlet is arranged at a first side of the chamber and the outlet is arranged at a second side opposite the first side.

In various embodiments, the heat sink is arranged at a first side of the chamber and the inlet is arranged at a second side of the chamber opposite the first side. In various embodiments, the heat sink is arranged at a first side of the chamber and the outlet is arranged at a second side of the chamber opposite the first side.

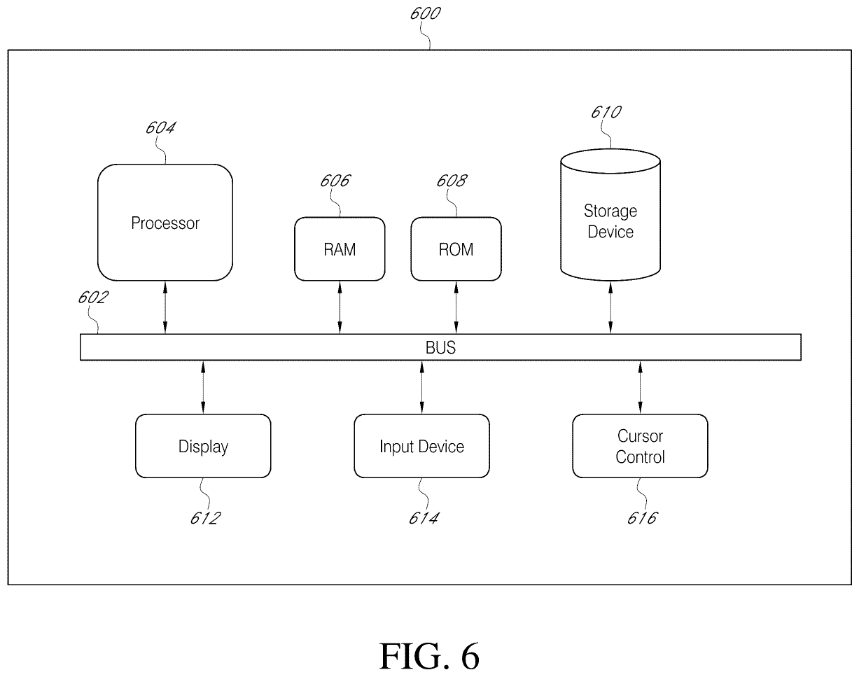

FIG. 6 is a block diagram of a computer system 600, in accordance with various embodiments. Computer system 600 may be configured to implementing thermal management of the cooling block 230 as described above in FIGS. 2A and 2B, and/or the cooling block 300 as described above in FIGS. 3A and 3B.

In one or more examples, computer system 600 can include a bus 602 or other communication mechanism for communicating information, and a processor 604 coupled with bus 602 for processing information. In various embodiments, computer system 600 can also include a memory, which can be a random-access memory (RAM) 606 or other dynamic storage device, coupled to bus 602 for determining instructions to be executed by processor 604. Memory also can be used for storing temporary variables or other intermediate information during execution of instructions to be executed by processor 604. In various embodiments, computer system 600 can further include a read only memory (ROM) 608 or other static storage device coupled to bus 602 for storing static information and instructions for processor 604. A storage device 610, such as a magnetic disk or optical disk, can be provided and coupled to bus 602 for storing information and instructions.

In various embodiments, computer system 600 can be coupled via bus 602 to a display 612, such as a cathode ray tube (CRT), liquid crystal display (LCD), or light emitting diode (LED) for displaying information to a computer user. An input device 614, including alphanumeric and other keys, can be coupled to bus 602 for communicating information and command selections to processor 604. Another type of user input device is a cursor control 616, such as a mouse, a joystick, a trackball, a gesture input device, a gaze-based input device, or cursor direction keys for communicating direction information and command selections to processor 604 and for controlling cursor movement on display 612. This input device 614 typically has two degrees of freedom in two axes, a first axis (e.g., x) and a second axis (e.g., y), that allows the device to specify positions in a plane. However, it should be understood that input devices 614 allowing for three-dimensional (e.g., x, y, and z) cursor movement are also contemplated herein.

Consistent with certain implementations of the present teachings, results can be provided by computer system 600 in response to processor 604 executing one or more sequences of one or more instructions contained in RAM 606. Such instructions can be read into RAM 606 from another computer-readable medium or computer-readable storage medium, such as storage device 610. Execution of the sequences of instructions contained in RAM 606 can cause processor 604 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 604 for execution. Such a medium can take many forms, including but not limited to, non-volatile media, volatile media, and transmission media. Examples of non-volatile media can include, but are not limited to, optical, solid state, magnetic disks, such as storage device 610. Examples of volatile media can include, but are not limited to, dynamic memory, such as RAM 606. Examples of transmission media can include, but are not limited to, coaxial cables, copper wire, and fiber optics, including the wires that comprise bus 602.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 604 of computer system 600 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 600 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 600, whereby processor 604 would execute the analyses and determinations provided by these engines, subject to instructions provided by any one of, or a combination of, the memory components RAM 606, ROM, 608, or storage device 610 and user input provided via input device 614.

### IV. Additional Recited Embodiments

Embodiment 1: An apparatus comprising: a thermal transfer block configured to receive a well plate having a plurality of wells, wherein the thermal transfer block comprises a base and a plurality of protrusions arranged on a first side of the base in a configuration such that each of the plurality of wells is received between a set of adjacent protrusions, and wherein each protrusion of the set of adjacent protrusions has a surface that substantially matches a portion of an outer surface of each well that is received between the set of adjacent protrusions; and a cooling block disposed in contact with a second side of the base of the thermal transfer block, wherein the cooling block comprises a heat sink having a plurality of fins immersed in a fluid for cooling.

Embodiment 2: The apparatus of embodiment 1, wherein the surface of a protrusion of the set of adjacent protrusions and the outer surface of the received well have matching contour surfaces so as to maximize heat transfer between the two surfaces.

Embodiment 3: The apparatus of embodiment 2, wherein between about 30% and about 95% of the outer surface area of the received well is in thermal contact with surfaces of the set of adjacent protrusions.

Embodiment 4: The apparatus of embodiments 2 or 3, wherein each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

Embodiment 5: The apparatus of any one of embodiments 1-4, wherein the set of adjacent protrusions comprises 3 protrusions.

Embodiment 6: The apparatus of any one of embodiments 1-5, wherein the set of adjacent protrusions comprises 4 protrusions.

Embodiment 7: The apparatus of any one of embodiments 1-6, wherein the base and the plurality of protrusions of the thermal transfer block are formed from a single block of material.

Embodiment 8: The apparatus of any one of embodiments 1-7, wherein the plurality of protrusions comprises aluminum or copper.

Embodiment 9: The apparatus of any one of embodiments 1-8, wherein the thermal transfer block comprises aluminum or copper.

Embodiment 10: The apparatus of any one of embodiments 1-9, wherein the thermal transfer block comprises a frame structure configured for alignment, correct placement, and/or to ensure proper thermal contact of the well plate onto/with the thermal transfer block.

Embodiment 11: The apparatus of any one of embodiments 1-10, wherein the cooling block further comprises: a thermo-electric cooling module (TEC) disposed between the thermal transfer block and the heat sink, wherein the TEC module is configured to regulate a temperature or a range of temperature of the well plate via the thermal transfer block so as to maintain each of the plurality of wells at the temperature or within the range of temperature.

Embodiment 12: The apparatus of embodiment 11, wherein the cooling block further comprises: a metal plate disposed in between the TEC module and thermal transfer block.

Embodiment 13: The apparatus of embodiments 11 or 12, wherein the cooling block comprises: a thermistor configured for measuring and controlling of the TEC module.

Embodiment 14: The apparatus of any one of embodiments 1-13, wherein the cooling block comprises: a proportional-integral-derivative (PID) controller configured to regulate the temperature of the plurality of wells within a predetermined temperature range.

Embodiment 15: The apparatus of any one of embodiments 1-14, further comprising: an insulation element disposed around the thermal transfer block.

Embodiment 16: The apparatus of embodiment 15, wherein the insulation element is foam.

Embodiment 17: The apparatus of any one of embodiments 1-16, further comprising: a radio-frequency identification (RFID) unit coupled to the cooling block.

Embodiment 18: The apparatus of any one of embodiments 1-17, wherein the thermal transfer block is a first thermal transfer block and the cooling block is a first cooling block, further comprising: a second thermal transfer block thermally isolated from the first thermal transfer block; and a second cooling block in contact with the second thermal transfer block, the second cooling block electrically isolated from the first cooling block.

Embodiment 19: The apparatus of embodiments 18, wherein the first cooling block is maintained at a first temperature or within a first preset range of temperatures and the second cooling block is maintained at a second temperature or within a second preset range of temperatures, wherein the first temperature is different from the second temperature and/or the first preset range of temperatures is different from the second preset range of temperatures.

Embodiment 20: The apparatus of any one of embodiments 1-19, wherein the plurality of fins of the heat sink are skived from a single block of aluminum or copper.

Embodiment 21: The apparatus of any one of embodiments 1-20, wherein the cooling block comprises a chamber with an inlet for introducing the fluid into the chamber for cooling the heat sink and an outlet for removing the fluid that passes through the plurality of fins of the heat sink.

Embodiment 22: The apparatus of any one of embodiments 1-21, wherein the plurality of fins of the heat sink are arranged such that the fluid flows along the plurality of fins.

Embodiment 23: The apparatus of embodiments 21 or 22, wherein the heat sink is arranged within the chamber such that the plurality of fins extend away from the thermal transfer block and wherein the fluid is introduced via the inlet into the chamber such that the fluid flows along the plurality of fins before exiting the chamber via the outlet.

Embodiment 24: The apparatus of any one of embodiments 21-23, wherein the heat sink is arranged within the chamber such that the inlet is perpendicular to the plurality of fins of the heat sink.

Embodiment 25: The apparatus of any one of embodiments 21-23, wherein the heat sink is arranged within the chamber such that the inlet is parallel to the plurality of fins of the heat sink.

Embodiment 26: The apparatus of any one of embodiments 21-23, wherein the heat sink is arranged within the chamber such that the inlet is oriented at an angle to the plurality of fins of the heat sink.

Embodiment 27: The apparatus of any one of embodiments 21-26, wherein the plurality of fins of the heat sink extend from a top surface of the chamber for an entire height of the chamber forming parallel channels of fluid flow from the inlet to the outlet.

Embodiment 28: The apparatus of any one of embodiments 21-26, wherein the plurality of fins of the heat sink extend from a top surface of the chamber for a portion of a height of the chamber forming semi-parallel channels of fluid flow between the inlet and the outlet.

Embodiment 29: The apparatus of any one of embodiments 21-28, wherein the inlet and the outlet are arranged on a same side of the chamber.

Embodiment 30: The apparatus of any one of embodiments 21-28, wherein the inlet is arranged at a first side of the chamber and the outlet is arranged at a second side opposite the first side.

Embodiment 31: The apparatus of any one of embodiments 21-28, wherein the inlet is arranged at a first side of the chamber and the outlet is arranged at a second side perpendicular to the first side.

Embodiment 32: The apparatus of any one of embodiments 21-28, wherein the inlet is arranged at a first side of the chamber and the outlet is arranged at a second side opposite the first side.

Embodiment 33: The apparatus of any one of embodiments 21-28, wherein the heat sink is arranged at a first side of the chamber and the inlet is arranged at a second side of the chamber opposite the first side.

Embodiment 34: The apparatus of any one of embodiments 21-28, wherein the heat sink is arranged at a first side of the chamber and the outlet is arranged at a second side of the chamber opposite the first side.

Embodiment 35: A method comprising: adjusting a temperature of a plurality of wells of a well plate via a thermo-electric cooling module (TEC) coupled to a plurality of protrusions extending between the plurality of wells of the well plate, wherein each of the plurality of wells is received between a set of adjacent protrusions.

Embodiment 36: The method of embodiment 35, wherein adjusting the temperature comprises increasing a temperature of the protrusions.

Embodiment 37: The method of embodiment 35, wherein adjusting the temperature comprises decreasing a temperature of the protrusions.

Embodiment 38: The method of any one of embodiments 35-37, further comprising: measuring, via a thermistor, the temperature of the plurality of wells.

Embodiment 39: The method of any one of embodiments 35-38, further comprising: regulating, via a proportional-integral-derivative (PID) controller, the temperature of the plurality of wells within a predetermined temperature range.

Embodiment 40: The method of any one of embodiments 35-39, wherein the adjusting of the temperature comprises energizing the TEC thereby decreasing the temperature of the plurality of wells.

Embodiment 41: The method of any one of embodiments 35-40, wherein the plurality of protrusions are coupled to a base that is in thermal contact with a first side of the TEC.

Embodiment 42: The method of embodiment 41, wherein a second side of the TEC is in thermal contact with a heat sink having a plurality of fins immersed in a fluid.

Embodiment 43: The method of embodiment 42, further comprising: cooling the TEC by flowing the fluid along the plurality of fins of the heat sink.

Embodiment 44: The method of embodiment 43, wherein the fluid is introduced via an inlet and removed via an outlet.

Embodiment 45: The method of any one of embodiments 35-44, wherein each protrusion of the set of adjacent protrusions has a surface that substantially matches a portion of an outer surface of each well that is received between the set of adjacent protrusions so as to maximize heat transfer between the two surfaces.

Embodiment 46: The method of embodiment 45, wherein between about 30% and about 95% of the outer surface area of the received well is in thermal contact with surfaces of the set of adjacent protrusions.

Embodiment 47: The method of embodiments 45 or 46, wherein each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

What is claimed:

1. An apparatus comprising:
a thermal transfer block configured to receive a well plate having a plurality of wells,
wherein the thermal transfer block comprises a base and a plurality of protrusions arranged on a first side of the base in a configuration such that each of the plurality of wells is received between a set of adjacent protrusions, and
wherein each protrusion of the set of adjacent protrusions has a surface that substantially matches a portion of an outer surface of each well that is received between the set of adjacent protrusions; and
a cooling block disposed in contact with a second side of the base of the thermal transfer block,
wherein the cooling block comprises a heat sink having a plurality of fins immersed in a fluid for cooling.

2. The apparatus of claim 1, wherein the surface of a protrusion of the set of adjacent protrusions and the outer surface of the received well have matching contour surfaces so as to maximize heat transfer between the two surfaces.

3. The apparatus of claim 2, wherein between about 30% and about 95% of the outer surface area of the received well is in thermal contact with surfaces of the set of adjacent protrusions.

4. The apparatus of claim 2, wherein each of the plurality of protrusions has a length of along the protrusion that matches a depth of a fluid chemical in each well such that the fluid chemical contained within each well, from a top surface of the fluid chemical to a bottom of the well, is in thermal contact with the matching contour surfaces of the set of adjacent protrusions.

5. The apparatus of claim 1, wherein the cooling block further comprises:
a thermo-electric cooling (TEC) module disposed between the thermal transfer block and the heat sink, wherein the TEC module is configured to regulate a temperature or a range of temperature of the well plate via the thermal transfer block so as to maintain each of the plurality of wells at the temperature or within the range of temperature.

6. The apparatus of claim 5, wherein the cooling block further comprises at least one of:
a metal plate disposed in between the TEC module and thermal transfer block;
a thermistor configured for measuring and controlling of the TEC module; or
a proportional-integral-derivative (PID) controller configured to regulate the temperature of the TEC module within a predetermined temperature range.

7. The apparatus of claim 1, further comprising:
an insulation element disposed around the thermal transfer block.

8. The apparatus of claim 1, wherein the thermal transfer block is a first thermal transfer block and the cooling block is a first cooling block, further comprising:
a second thermal transfer block thermally isolated from the first thermal transfer block; and
a second cooling block in contact with the second thermal transfer block, the second cooling block electrically isolated from the first cooling block.

9. The apparatus of claim 8, wherein the first cooling block is maintained at a first temperature or within a first preset range of temperatures and the second cooling block is maintained at a second temperature or within a second preset range of temperatures, wherein the first temperature is different from the second temperature and/or the first preset range of temperatures is different from the second preset range of temperatures.

10. The apparatus of claim 1, wherein the cooling block comprises a chamber with an inlet for introducing the fluid into the chamber for cooling the heat sink and an outlet for removing the fluid that passes through the plurality of fins of the heat sink.

11. The apparatus of claim 1, wherein the plurality of fins of the heat sink are arranged such that the fluid flows along the plurality of fins.

12. The apparatus of claim 10, wherein the heat sink is arranged within the chamber such that the plurality of fins extend away from the thermal transfer block and wherein the fluid is introduced via the inlet into the chamber such that the fluid flows along the plurality of fins before exiting the chamber via the outlet.

13. The apparatus of claim 10, wherein the heat sink is arranged within the chamber such that the inlet is perpendicular to the plurality of fins of the heat sink.

14. The apparatus of claim 10, wherein the heat sink is arranged within the chamber such that the inlet is parallel to the plurality of fins of the heat sink.

15. The apparatus of claim 10, wherein the heat sink is arranged within the chamber such that the inlet is oriented at an angle to the plurality of fins of the heat sink.

16. The apparatus of claim 10, wherein the plurality of fins of the heat sink extend from a top surface of the chamber for an entire height of the chamber forming parallel channels of fluid flow from the inlet to the outlet.

17. The apparatus of claim 10, wherein the plurality of fins of the heat sink extend from a top surface of the chamber for a portion of a height of the chamber forming semi-parallel channels of fluid flow between the inlet and the outlet.

18. The apparatus of claim 10, wherein the inlet and the outlet are arranged on a same side of the chamber.

19. The apparatus of claim 10, wherein the inlet is arranged at a first side of the chamber and the outlet is arranged at a second side, wherein the second side is opposite the first side or perpendicular to the first side.

20. The apparatus of claim 10, wherein the heat sink is arranged at a first side of the chamber and one of the inlet or the outlet is arranged at a second side of the chamber opposite the first side.
